(19) United States
(12) Patent Application Publication
(10) Pub. No.: US 2026/0134459 A1
(43) Pub. Date: May 14, 2026

(54) IN-VEHICLE DEVICE, SERVICE PROVISION SYSTEM, SERVICE PROVISION METHOD, AND STORAGE MEDIUM STORING SERVICE PROVISION PROGRAM

(71) Applicant: DENSO CORPORATION, Kariya-city (JP)

(72) Inventors: Yukihiro YAMAKAWA, Kariya-city (JP); Hideyuki YAMAGUCHI, Kariya-city (JP)

(21) Appl. No.: 19/413,857

(22) Filed: Dec. 9, 2025

Related U.S. Application Data
(63) Continuation of application No. PCT/JP2024/021020, filed on Jun. 10, 2024.

(30) Foreign Application Priority Data
Jun. 12, 2023 (JP) 2023-096246

(51) Int. Cl. G06Q 30/0601

(52) U.S. Cl. CPC G06Q 30/0601

(57) ABSTRACT

An in-vehicle device comprises a cooperation controller configured to implement cooperation between a service application and a functional block. The functional block includes a functional interface configured to convert an access request into a vehicle-dependent format. The cooperation controller is configured to transfer the access request transmitted from the service application to the functional block. The cooperation controller includes: an access control method determination unit configured to determine an access control method for controlling transfer of the access request to the functional block; and an access permission determination unit configured to determine whether to permit the access request.

### CROSS REFERENCE TO RELATED APPLICATIONS

The present application is a continuation application of International Patent Application No. PCT/JP 2024/021020 filed on Jun. 10, 2024, which designated the U.S. and claims the benefit of priority from Japanese Patent Application No. 2023-096246 filed on Jun. 12, 2023. The entire disclosures of all of the above applications are incorporated herein by reference.

### TECHNICAL FIELD

The present disclosure relates to an in-vehicle device, a service provision system, a service provision method, and a service provision program for providing a service to a vehicle.

### BACKGROUND

A sharing mobility system including multiple user terminals used by users using vehicles, multiple carport devices placed at a carport, and a server managed by a provider that provides a mobility service to the user has been known as a comparative example. In the sharing mobility system of the comparative example, a server calculates an estimated revenue amount that the provider can obtain from the user when the user uses a vehicle that is parked at the carport and can be used.

### SUMMARY

According to an aspect of the present disclosure, an in-vehicle device comprises at least one of (i) a circuit and (ii) a processor with a memory storing computer program code executable by the processor, the at least one of the circuit and the processor configured to cause the in-vehicle device to implement cooperation between a service application and a functional block. The functional block includes a functional interface configured to convert an access request into a vehicle-dependent format. The at least one of the circuit and the processor is further configured to cause the in-vehicle device to: transfer the access request transmitted from the service application to the functional block; determine an access control method for controlling transfer of the access request to the functional block; and determine whether to permit the access request.

### BRIEF DESCRIPTION OF THE DRAWINGS

FIG. 1 is a block diagram showing a configuration of a service provision system.

FIG. 2 is a block diagram showing a configuration of an ECU.

FIG. 3 is a block diagram showing a charging procedure.

FIG. 4 is a block diagram showing a transmission path of information.

FIG. 5 is a block diagram illustrating operations of a service provision system.

FIG. 6 is a diagram showing a use setting table.

FIG. 7 is a diagram showing a setting method of compulsory use.

FIG. 8 is a diagram showing a first specific example of determining an access control method.

FIG. 9 is a diagram showing a second specific example of determining an access control method.

FIG. 10 is a block diagram illustrating operations of an access permission determination unit and an access control execution unit.

FIG. 11 is a block diagram illustrating operations of an access control execution unit and an access log management unit.

FIG. 12 is a sequence diagram showing a procedure for setting API use conditions and a procedure for setting API compulsory use permission.

FIG. 13 is a sequence diagram showing a procedure for determining access permission.

FIG. 14 is a sequence diagram showing a procedure for causing a user to set the API compulsory use permission.

### DETAILED DESCRIPTION

When a service provider provides a service to a vehicle, it may be necessary to acquire vehicle information related to the vehicle from a target vehicle that is a service provision target, or cause the target vehicle to perform a predetermined operation or process.

In this way, when the service provider uses a vehicle by acquiring vehicle information from the vehicle or causing the vehicle to perform the predetermined operation or process, it is desirable to appropriately charge the service provider according to the use of the vehicle.

As a result of detailed study by the inventors, it has been found that when the vehicle use fee generated by the use of the vehicle by the service provider dynamically changes, the monthly cost of the service provider may fluctuate and become unstable.

The present disclosure reduces fluctuations in fees generated by the use of the vehicle by the service provider.

One aspect of the present disclosure is an in-vehicle device that is mounted on a vehicle and connected to a plurality of electronic control units by an in-vehicle network.

An in-vehicle device of the present disclosure includes: a cooperation controller configured to implement cooperation between a service application configured to provide a service to the vehicle and a functional block configured to execute a process predetermined in the vehicle. The functional block includes a functional interface configured to convert an access request that is expressed in a vehicle-independent format and transmitted from the service application into a vehicle-dependent format. The cooperation controller is configured to transfer the access request transmitted from the service application to the functional block.

The cooperation controller includes an access control method determination unit and an access permission determination unit.

The access control method determination unit is configured to determine an access control method for controlling transfer of an access request to a functional block based on a current interface use fee information, a future estimation amount information, and an interface use condition set for using a functional interface by a servicer that provides a service to a vehicle using a service application. The current interface use fee information indicates a current interface use fee that is an interface use fee generated by a service application using the functional interface at the current time. The future estimation amount information indicates a future estimation amount that is an estimation amount of an interface use fee generated by a service application using the functional interface in the future.

The access permission determination unit is configured to determine whether to permit the access request based on the access control method determined by the access control method determination unit and a request of a vehicle control system including the plurality of electronic control units and the in-vehicle device.

The in-vehicle device of the present disclosure configured in such a manner can cause the service application to use the functional interface when the current interface use fee and the future estimation amount satisfy the interface use condition set by the servicer. Thereby, the in-vehicle device of the present disclosure can prevent the occurrence of a situation where the service application uses the functional interface when the current interface use fee and the future estimation amount are higher than expected by the servicer. Therefore, the in-vehicle device of the present disclosure can reduce fluctuation in charges caused by the servicer using the vehicle.

According to another aspect of the present disclosure, a service provision system includes: a vehicle control system including a plurality of electronic control units mounted on a vehicle and connected to an in-vehicle network and a cooperation controller configured to implement cooperation between a service application and a functional block; and a server configured to communicate data with the vehicle control system. The cooperation controller includes an access control method determination unit and an access permission determination unit.

The service provision system of the present disclosure configured in this manner is a system including the in-vehicle device of the present disclosure and can achieve the same effects as the in-vehicle device of the present disclosure.

Further, another aspect of the present disclosure is a service provision method executed by an in-vehicle device that is mounted on a vehicle and connected to a plurality of electronic control units by an in-vehicle network. The in-vehicle device includes a functional interface and a cooperation controller.

In the service provision method of the present disclosure, the in-vehicle device determines an access control method for controlling transfer of an access request to a functional block based on a current interface use fee information, a future estimation amount information, and an interface use condition set for using a functional interface by a servicer that provides a service to a vehicle using a service application. Further, the in-vehicle device determines whether to permit the access request based on the determined access control method and a request of a vehicle control system including a plurality of electronic control units and an in-vehicle device.

The service provision method of the present disclosure is a method executed by the in-vehicle device of the present disclosure. By executing the method, the same effects as those of the in-vehicle device of the present disclosure can be achieved.

Further, according to another aspect of the present disclosure, a service provision program is for causing a computer of an in-vehicle device mounted on a vehicle and connected to a plurality of electronic control units by an in-vehicle network to function as a functional interface, a cooperation controller, an access control method determination unit, and an access permission determination unit.

The computer controlled by the service provision program of the present disclosure can configure a part of the in-vehicle device of the present disclosure, and can achieve the same effects as the in-vehicle device of the present disclosure.

Hereinafter, an embodiment of the present disclosure will be described with reference to the drawings.

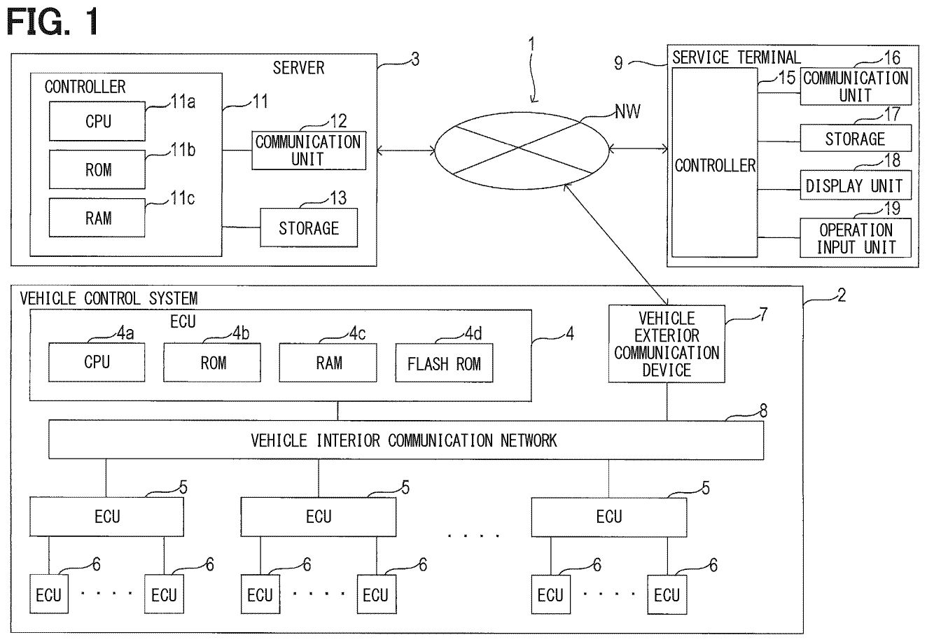

As shown in FIG. 1, a service provision system 1 of the present embodiment includes a vehicle control system 2 and a server 3.

The vehicle control system 2 is mounted on a vehicle and has a function of performing data communication with the server 3 via a wide area wireless communication network NW.

The server 3 has a function of performing data communication with the vehicle control system 2 via the wide area wireless communication network NW. An application store accessible via the wide area wireless communication network NW or the Internet is installed in the server 3.

A vehicle equipped with the vehicle control system 2 may have an automated driving function in addition to a manual driving function. The vehicle may be a hybrid vehicle having an engine and an electric motor as a traveling source. The vehicle is not limited to the vehicle having the automated driving function or the hybrid vehicle, but may be a vehicle having only a manual driving function, or a vehicle having only an engine or only an electric motor as the travel driving source. Hereinafter, the vehicle equipped with the vehicle control system 2 will be simply referred to as a vehicle.

The vehicle control system 2 includes one ECU 4, multiple ECUs 5, multiple ECUs 6, a vehicle exterior communication device 7, and a vehicle interior communication network 8. The ECU is an abbreviation for Electronic Control Unit.

The ECU 4 controls the multiple ECUs 5 to achieve coordinated control of the entire vehicle.

The ECU 5 is provided for each domain divided by function in the vehicle, and mainly controls multiple ECUs 6 existing within the domain. Each ECU 5 is connected to the ECU 6 under the control thereof via an individually provided lower layer network (for example, CAN). The CAN is an abbreviation for Controller Area Network. The CAN is a registered trademark. The domains are, for example, a powertrain, a body, a chassis, a cockpit, and the like.

The ECUs 6 connected to the ECU 5 belonging to the powertrain domain include, for example, an ECU 6 that controls an engine, an ECU 6 that controls a motor, and an ECU 6 that controls the battery.

The ECUs 6 connected to the ECU 5 belonging to the body domain include, for example, an ECU 6 that controls an air conditioner, and an ECU 6 that controls a door.

The ECUs 6 connected to the ECU 5 belonging to the chassis domain include, for example, an ECU 6 that controls braking, and an ECU 6 that controls steering.

The ECUs 6 connected to the ECU 5 belonging to the cockpit domain includes, for example, an ECU 6 that controls display of a meter and navigation, and an ECU 6 that controls an input device operable by an occupant of the vehicle.

The vehicle exterior communication device 7 performs data communication with the server 3 via the wide area wireless communication network NW.

The vehicle interior communication network 8 includes CAN FD and Ethernet. The Ethernet is a registered trademark. The CAN FD is an abbreviation for CAN with Flexible Data Rate. The CAN FD connects the ECU 4 to each of the ECUs 5 and the vehicle exterior communication device 7 via a bus. The Ethernet individually connects the ECU 4 to each of the ECUs 5 and the vehicle exterior communication device 7.

The ECU 4 is an electronic control unit that mainly includes a microcomputer including a CPU 4a, a ROM 4b, and a RAM 4c. Various functions of the microcomputer are implemented by the CPU 4a executing programs stored in a non-transitory tangible storage medium. In this example, the ROM 4b corresponds to a non-transitory tangible storage medium that stores a program. Further, by executing this program, a method corresponding to the program is executed. Some or all of the functions executed by the CPU 4a may be configured in hardware using one or more ICs. Further, the number of the microcomputers constituting the ECU 4 may be one or more.

The ECU 4 further includes a flash ROM 4d. The flash ROM 4d is a non-volatile memory capable of rewriting the storage contents.

Like the ECU 4, the ECU 5, the ECU 6, and the vehicle exterior communication device 7 are each an electronic control unit mainly including a microcomputer including a CPU, a ROM and a RAM. Further, the number of microcomputers constituting each of the ECUs 5, each of the ECUs 6, and the vehicle exterior communication device 7 may be one or more. The ECU 5 controls one or more ECUs 6. The ECU 4 controls one or more ECUs 5, or controls the ECUs 5 and 6 of the entire vehicle and the vehicle exterior communication device 7.

Hereinafter, unless otherwise specified, the ECU 4, ECU 5, ECU 6, and the vehicle exterior communication device 7 will be collectively referred to as in-vehicle devices 4 to 7.

The server 3 includes a controller 11, a communication unit 12, and a storage 13.

The controller 11 is an electronic control unit mainly including a microcomputer including a CPU 11a, a ROM 11b, a RAM 11c, and the like. Various functions of the microcomputer are implemented by the CPU 11a executing programs stored in a non-transitory tangible storage medium. In this example, the ROM 11b corresponds to a non-transitory tangible storage medium that stores a program. Further, by executing this program, a method corresponding to the program is executed. Some or all of the functions executed by the CPU 11a may be configured in hardware using one or more ICs. The number of microcomputers included in the controller 11 may be one or more.

The communication unit 12 performs data communication with the vehicle control system 2 through the wide area wireless communication network NW. The storage 13 is a storage device for storing various data.

The service provision system 1 further includes a servicer terminal device 9. The servicer terminal device 9 is a device managed by a service provider SV (hereinafter, servicer SV) described later, and is, for example, a personal computer.

The servicer terminal device 9 includes a controller 15, a communication unit 16, a storage 17, a display unit 18, and an operation input unit 19.

The controller 15 is an electronic control unit mainly including a microcomputer with a CPU, a ROM, a RAM, and the like.

The communication unit 16 performs data communication with the vehicle control system 2 and the server 3 via the wide area wireless communication network NW. The storage 17 is a storage device for storing various data. The display unit 18 includes a display device that is not shown in the drawings and displays various images on a display screen of the display device. The operation input unit 19 outputs input operation information for identifying input operations performed by the user via a keyboard and a mouse (not shown).

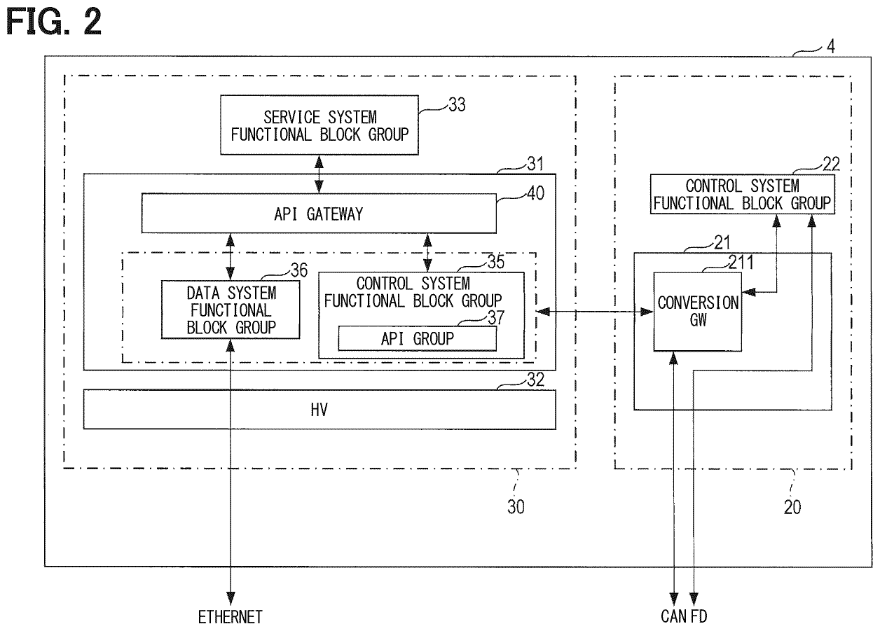

As shown in FIG. 2, the ECU 4 includes a real-time processing unit 20 and an application processing unit 30 (hereinafter also referred to as an app processing unit 30). When the ECU 4 includes multiple CPUs 4a, the real-time processing unit 20 and the application processing unit 30 may be implemented by processes executed by the same CPU or by processes executed by different CPUs.

The real-time processing unit 20 cooperates with the in-vehicle devices 5 to 7 connected via the CAN FD to execute vehicle control and the like that requires real-time performance. The application processing unit 30 cooperates with the in-vehicle devices 5 to 7 connected via Ethernet to execute various applications (for example, entertainment applications) that require high processing performance.

The application processing unit 30 has a function to transmit instructions based on the processes of various applications to the real-time processing unit 20. The real-time processing unit 20 has a function to transmit information, and the like collected from the ECU and the like, to the application processing unit 30 via the CAN FD. Thereby, the real-time processing unit 20 and the application processing unit 30 cooperate with each other to implement various functions.

The software of the vehicle control system 2 is built along AUTOSAR. The AUTOSAR is an abbreviation for automated driving and an abbreviation for Automotive Open System Architecture. The AUTOSAR is a registered trademark. The AUTOSAR provides not only communication between software components (hereinafter referred to as SW-C) provided to implement various applications, but also functions related to connection to the cloud, security, and the like. The SW-C is parted software to implement a certain function. The application program includes one or more SW-C. Note that the software of the vehicle control system 2 does not necessarily need to be built along AUTOSAR.

Each device belonging to the vehicle control system 2, that is, the ECU 4, the ECU 5, the ECU 6, and the vehicle exterior communication device 7, are all provided with a platform. The platform provides an environment for running SW-C written in a hardware-independent format.

The platform includes a runtime environment (hereinafter, RTE) and base software (hereinafter, BSW). The RTE is the interface between SW-C and between SW-C and BSW. The BSW is the hierarchy connecting hardware and SW-C, including OS, driver, middleware, etc. The functions of the BSW are divided into small modules and the functions of each module are provided to the SW-C via API. The API is an abbreviation for Application Programming Interface.

Hereinafter, the platform provided in the real-time processing unit 20 is referred to as a first platform 21 (hereinafter, first PF 21), and the platform provided in the application processing unit 30 is referred to as a second platform 31 (hereinafter, second PF 31).

The real-time processing unit 20 includes a control system functional block group 22 as a collection of service applications (hereinafter referred to as service apps) operating on the first PF 21. The service app is an application that receives requests from clients, processes them, and returns results.

The control system functional block group 22 is a group of applications for providing an API for accepting instructions related to the movement of the vehicle and for controlling the instructions accepted by the API to implement consistent vehicle control. The control system functional block group 22 outputs various instructions via the vehicle interior communication network 8 to the in-vehicle devices 5 to 7 in which there is an object that executes control based on the instructions.

The first PF 21 includes a conversion gateway 211. The conversion gateway 211 has a function to convert the communication frame received by the real-time processing unit 20 via the CAN FD into Ethernet format and provide it to the application processing unit 30. In addition, the conversion gateway 211 has a function to convert the communication frame in the Ethernet format provided by the application processing unit 30 to the CAN format.

The application processing unit 30 includes a hypervisor 32, and executes software on multiple virtual machines. Note that the hypervisor 32 may be omitted.

The application processing unit 30 includes a service system functional block group 33 as a collection of service applications operating on the second PF 31.

The service system functional block group 33 is a collection of service applications. Each service application shall have one or more SW-C. The service applications are provided by third parties as well as the vehicle manufacturer who manufactured the vehicle. The third party that provides service applications includes, for example, data utilization companies that provide services by collecting data from vehicles.

The second PF 31 includes a control system functional block group 35, a data system functional block group 36, and an API gateway 40.

The control system functional block group 35 is a set of programs equipped with an API for accepting requests related to vehicle control from the service system functional block group 33. The control system functional block group 35 includes an API group 37 composed of multiple APIs, and converts the API access request that is expressed in a vehicle-independent format and from the service system functional block group 33 into an API access request expressed in a vehicle-dependent format and provides it to the real-time processing unit 20. The “vehicle-independent format” described above is a format common to vehicles (i.e., a format that absorbs differences in vehicle types). The “vehicle-dependent format” described above is a format specific to the vehicle.

The API provided by the control system functional block group 35 includes a motion system API for controlling motion of the vehicle and a non-motion system API other than the motion system API. The API access request accepted by the motion system API is transferred to the control system functional block group 35, and is transferred from the control system functional block group 35 to the in-vehicle devices 5 to 7 which execute control based on the request via the vehicle interior communication network 8. The API access request accepted by the non-motion system API is transferred to the in-vehicle devices 5 to 7 which execute control based on the request via the vehicle interior communication network 8.

The data system functional block group 36 is a set of programs equipped with an API for handling vehicle data acquired and stored via the real-time processing unit 20. The data system functional block group 36 has a function of abstracting and storing vehicle data expressed in the vehicle-dependent format supplied from the real-time processing unit 20 into the vehicle-independent format. The data system functional block group 36 may have an API that provides a function to transmit designated vehicle data to the ECU or the like via the Ethernet. In particular, when the transmission destination is the vehicle exterior communication device 7, the vehicle exterior communication device 7 may upload the transmitted vehicle data to the cloud.

It should be noted that communication with other in-vehicle devices 5 to 7 via the control system functional block group 35 is not limited to CAN FD, but Ethernet or other communication means may be used. In addition, communication with other in-vehicle devices 5 to 7 via the data system functional block group 36 may be performed not only by Ethernet, but also by CAN FD or other communication means.

The API gateway 40 is configured by utilizing the functions of the virtual function bus (hereinafter referred to as VFB). The VFB is middleware that enables communication between SW-Cs and between SW-C and BSW without awareness of hardware or communication protocol, also called software bus. Communication between SW-Cs is access to API provided by another SW-C from SW-C. Communication between SW-C and BSW is access to API provided by control system functional block group 35 and data system functional block group 36 from SW-C.

That is, the SW-Cs access various APIs via the API gateway 40 and use the functions provided by the accessed APIs to implement desired functions.

The SW-C transmits an API access request when using the API. The API access request includes at least the application ID of the service application including the SW-C from which the request is made and the API-ID, the information indicating the API to which the request is made.

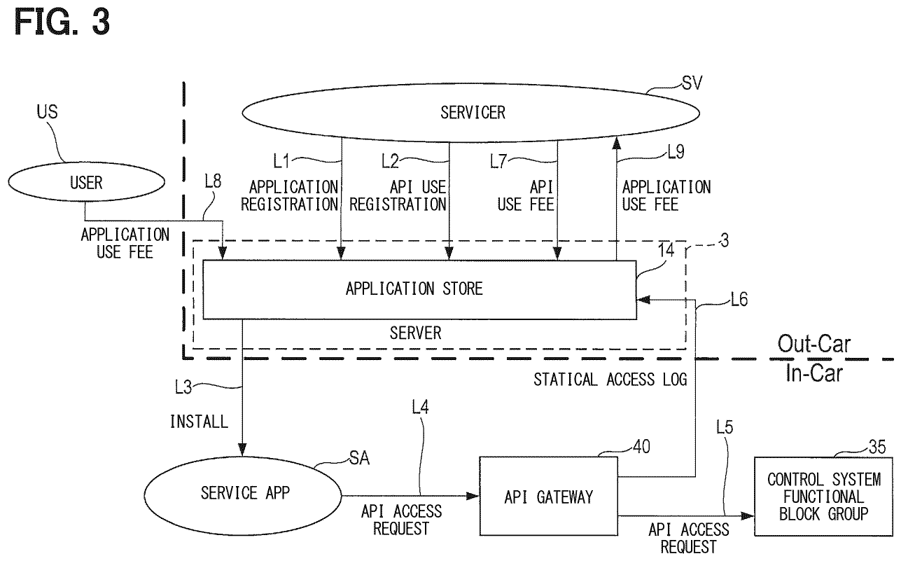

As shown in FIG. 3, an application store 14 is installed in the server 3. As indicated by an arrow L1, the application store 14 has a function of registering a service application SA manufactured by the servicer SV in the application store 14 based on an application by the servicer SV that has accessed the application store 14 using the servicer terminal device 9. The service application SA registered in the application store 14 is posted on the website of the application store 14.

Further, the application store 14 has a function of registering the API used by the service application SA in the application store 14 based on the application by the servicer SV, as indicated by an arrow L2.

When the user US accesses the website of the application store 14 and purchases the service application SA, the service application SA is installed in the ECU 4 placed in the vehicle of the user US, as indicated by an arrow L3.

As indicated by an arrow L4, when the service application SA transmits an API access request to the API gateway 40, the API gateway 40 transfers the API access request to the control system functional block group 35 as indicated by an arrow L5. As described above, the control system functional block group 35 converts the API access request into an API access request expressed in the vehicle-dependent format and provides it to the real-time processing unit 20.

As indicated by an arrow L6, the API gateway 40 transmits, to the application store 14, a statistical access log including the number of API uses taking into account the execution achievement status of the API access request and the amount of communication data associated with the API use.

The application store 14 calculates the API use fee generated by the use of the API by the service application SA based on the statistical access log received from the API gateway 40, and charges the servicer SV the API use fee. The servicer SV pays the charged API use fee to the application store 14, as indicated by an arrow L7.

The application store 14 calculates the application use fee of the service application SA based on the use state of the service application SA, and charges the user US the application use fee. As indicated by an arrow L8, the user US pays the charged application use fee to the application store 14. As indicated by an arrow L9, the application store 14 transfers the application use fee paid by the user US to the servicer SV.

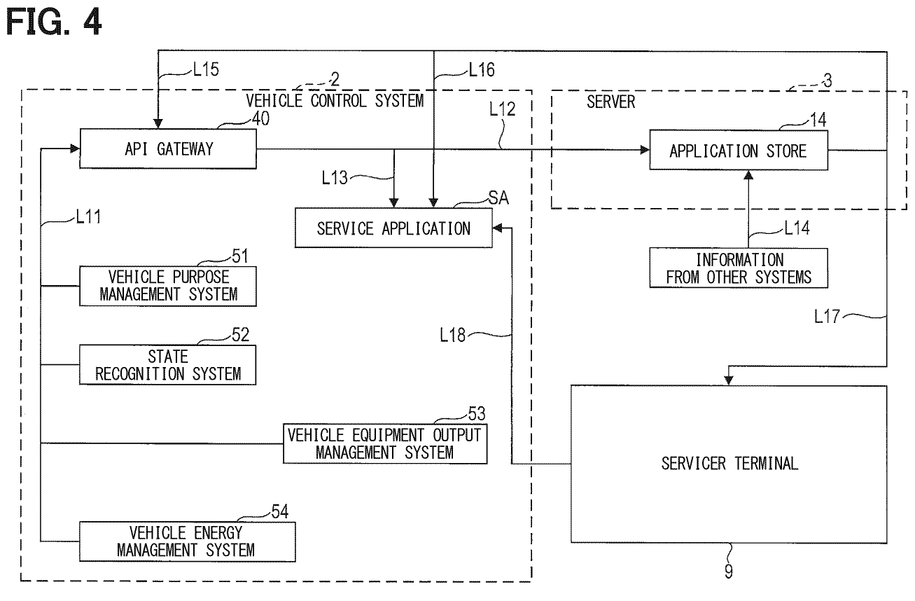

As shown in FIG. 4, the vehicle control system 2 includes a vehicle purpose management system 51, a state recognition system 52, a vehicle equipment output management system 53, and a vehicle energy management system 54.

The vehicle purpose management system 51 includes one or more ECUs 5 and 6 and has a function of generating a long-term plan for vehicle operation. The long-term plan of the vehicle operation includes a traveling schedule, a cabin temperature plan, an equipment operation application use plan, and the like.

The traveling schedule is prepared to reflect differences in brake and accelerator seasonings that differ depending on the vehicle and differences in driving characteristics of individuals. The traveling schedule is, for example, a vehicle speed profile, and is represented by a two-dimensional graph in which a horizontal axis is a time point [s] and a vertical axis is a vehicle speed [km/h].

The cabin temperature plan is, for example, an air conditioning profile, and is represented by a two-dimensional graph in which a horizontal axis is a time point [s] and a vertical axis is a temperature [° C.].

The device operation application use plan is, for example, a battery charge profile, and is represented by a two-dimensional graph in which a horizontal axis is a time point [s] and a vertical axis is a charge rate [%].

The state recognition system 52 includes one or more ECUs 5 and 6 and has a function of generating current vehicle information, current occupant information, current peripheral information, and a vehicle CPU load profile.

The current vehicle information is, for example, the current vehicle speed of the vehicle. The current occupant information is, for example, the occupant's alertness level. The current periphery information is, for example, a sign existing in the periphery of the vehicle. The vehicle CPU load profile is, for example, a CPU load estimation plan until the vehicle arrives at the destination.

The vehicle equipment output management system 53 includes one or more ECUs 5 and 6 and has a function of generating current equipment operation state information and a vehicle equipment operation profile.

The current equipment operation state information indicates, for example, whether the vehicle light is on. The vehicle equipment operation profile is, for example, a two-dimensional graph in which a light is used in a tunnel or the like before reaching a destination, and a horizontal axis is a time point [s] and a vertical axis is a power [kWh].

The vehicle energy management system 54 includes one or more ECUs 5 and 6 and has a function of generating current vehicle energy state information and an energy long-term plan.

The current vehicle energy state information is, for example, information indicating the state of charge (that is, SOC) of the power storage device mounted on the vehicle. The SOC is an abbreviation of the state of charge.

The energy long-term plan is, for example, a battery load profile that predicts the SOC until the vehicle arrives at the destination, and is represented by a two-dimensional graph in which a horizontal axis is a time [seconds] and a vertical axis is a charge rate [%].

As indicated by an arrow L11, the API gateway 40 acquires various pieces of information generated by the vehicle purpose management system 51, the state recognition system 52, the vehicle equipment output management system 53, and the vehicle energy management system 54, and calculates the current API use fee and the future estimation amount of the API use fee.

As indicated by arrows L12 and L13, the API gateway 40 notifies the application store 14 and the service application SA of the calculated current API use fee and the future estimation amount of the API use fee.

The application store 14 acquires current API use fee information indicating the current API use fee and API estimation amount information indicating the future estimation amount of the API use fee from the API gateways 40 of the multiple vehicles. The application store 14 acquires information from other systems, as indicated by an arrow L14. The information from the different systems includes, for example, energy supply-demand information of the electric power company and rapid charger congestion information indicating the congestion status of the rapid charger.

The application store 14 calculates the future estimation amount of the vehicle API use fee using information acquired from the API gateways 40 and other systems of the multiple vehicles.

As indicated by arrows L15 and 16, the application store 14 notifies the API gateway 40 and the service application SA of the future estimation amount of the calculated vehicle API use fee.

As indicated by an arrow L17, the application store 14 notifies the servicer terminal device 9 of the current API use fee and the future estimation amount of the API use fee acquired from the API gateway 40 and the calculated future estimation amount of the vehicle API use fee.

As indicated by an arrow L18, the servicer terminal device 9 can set whether the service application SA will use the API based on the current API use fee and the future estimation amount of the API use fee.

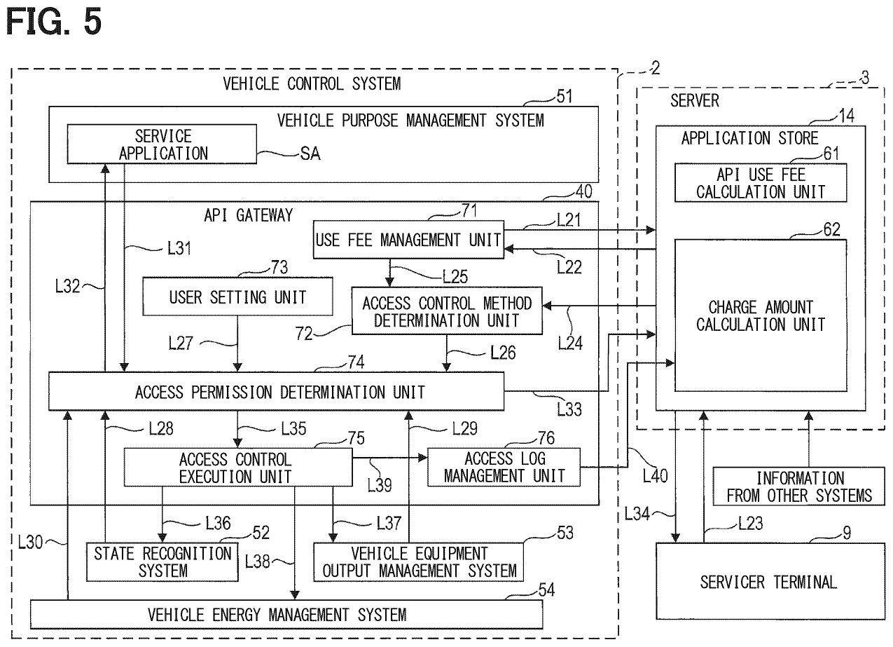

As shown in FIG. 5, the application store 14 includes an API use fee calculation unit 61 and a charge amount calculation unit 62.

As described above, the API use fee calculation unit 61 calculates the future estimation amount of the vehicle API use fee using information acquired from the API gateways 40 and other systems of the multiple vehicles.

As described above, the charge amount calculation unit 62 calculates the API use fee generated by the use of the API by the service application SA based on the statistical access log received from the API gateway 40. As described above, the charge amount calculation unit 62 calculates the application use fee of the service application SA based on the utilization status of the service application SA.

The API gateway 40 includes a use fee management unit 71, an access control method determination unit 72, a user setting unit 73, an access permission determination unit 74, an access control execution unit 75, and an access log management unit 76.

As described above, the use fee management unit 71 calculates the current API use fee and the future estimation amount of the API use fee. As indicated by an arrow L21, the use fee management unit 71 notifies the application store 14 of the calculated current API use fee and the future estimation amount of the API use fee.

As indicated by an arrow L22, the application store 14 notifies the use fee management unit 71 of the future estimation amount of the vehicle API use fee calculated by the API use fee calculation unit 61.

As indicated by an arrow L23, the servicer terminal device 9 accesses the application store 14 and sets a usage condition (hereinafter, API usage condition) for the API used by the service application SA based on the input operation by the servicer SV via the operation input unit 19.

As indicated by an arrow L24, the application store 14 notifies the access control method determination unit 72 of the set API use conditions.

As indicated by an arrow L25, the use fee management unit 71 notifies the access control method determination unit 72 of the current API use fee calculated by the use fee management unit 71, and the future estimation amount of the API use fee, and the future estimation amount of the vehicle API use fee acquired from the application store 14.

As indicated by an arrow L26, the access control method determination unit 72 determines the access control method based on the above information acquired from the use fee management unit 71 and the API use conditions acquired from the application store 14, and instructs the access permission determination unit 74 on the determined access control method. Details of the access control method determined by the access control method determination unit 72 will be described later.

As indicated by an arrow L27, the user setting unit 73 sets whether to permit the compulsory use of the API by the service application SA by charging the user US based on the input operation by the user US via the above-described input device mounted on the vehicle, and instructs the access permission determination unit 74 on whether to permit the set compulsory use. Details of the compulsory use permission set by the user setting unit 73 will be described later.

As indicated by an arrow L28, the state recognition system 52 notifies the access permission determination unit 74 of the future estimation availability information. The future estimation availability information notified by the state recognition system 52 is, for example, information indicating a future estimation of the available CPU usage.

As indicated by an arrow L29, the vehicle equipment output management system 53 notifies the access permission determination unit 74 of the future estimation availability information. The future estimation availability information provided by the vehicle equipment output management system 53 is, for example, information indicating future estimations of the amount of available communication data.

As indicated by an arrow L30, the vehicle energy management system 54 notifies the access permission determination unit 74 of the future estimation availability information. The future estimation availability information provided by the vehicle energy management system 54 is, for example, information indicating a future estimation of the available battery usage.

The service application SA installed in the vehicle purpose management system 51 transmits an API access request to the access permission determination unit 74, as indicated by an arrow L31.

The access permission determination unit 74 determines the availability of the API according to the API access request received from the service application SA based on the access control method for which instruction is provided by the access control method determination unit 72, the compulsory use permission for which instruction is provided by the user setting unit 73, and future estimation availability information acquired from the state recognition system 52, the vehicle equipment output management system 53, and the vehicle energy management system 54.

As indicated by arrows L32 and L33, the access permission determination unit 74 notifies the service application SA and the application store 14 of the availability determination result (hereinafter, API availability determination result) of the API according to the API access request received from the service application SA.

As indicated by an arrow L34, the application store 14 transfers the API availability determination result acquired from the access permission determination unit 74 to the servicer terminal device 9.

When permitting the use of the API according to the API access request received from the service application SA, the access permission determination unit 74 transmits the permitted API access request and an API execution method instruction indicating how to execute the API access request (hereinafter referred to as an access execution method) to the access control execution unit 75, as indicated by an arrow L35.

The access control execution unit 75 transfers the API access request to the control system functional block group 35 in accordance with the access execution method indicated by the API execution method instruction. Thereby, as indicated by arrows L36, L37, and L38, control based on the API access request is executed by at least one of the state recognition system 52, the vehicle equipment output management system 53, or the vehicle energy management system 54. An arrow L36 indicates that one or more ECUs 5 and 6 configuring the state recognition system 52 execute the process in response to the API access request. An arrow L37 indicates that one or more ECUs 5 and 6 configuring the vehicle equipment output management system 53 execute the process in response to the API access request. An arrow L38 indicates that one or more ECUs 5 and 6 configuring the vehicle energy management system 54 execute the process in response to the API access request.

As indicated by an arrow L39, the access control execution unit 75 creates an access log indicating the result of executing the process according to the API access request, and notifies the access log management unit 76 of the generated access log.

The access log management unit 76 transmits the access log acquired from the access control execution unit 75 to the application store 14.

Next, a method for the servicer SV to set the API use conditions will be described.

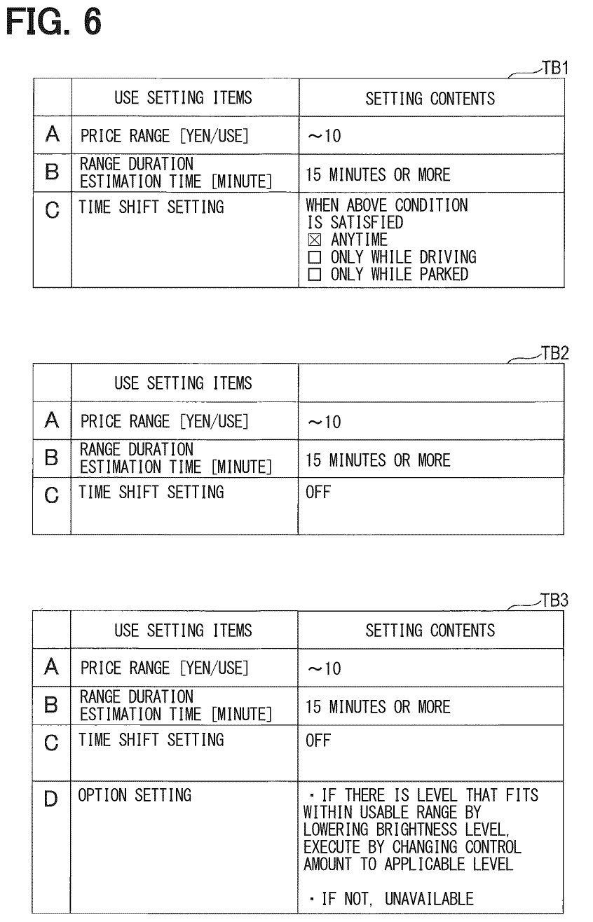

As shown in FIG. 6, one or more use setting items for setting API use conditions are set in advance for each of multiple APIs.

The use setting table TB1, the use setting table TB2, and the use setting table TB3 shown in FIG. 6 indicate the use setting items and setting contents of the first API, the second API, and the third API, respectively.

The first API is, for example, an API for executing a process of transmitting a driving operation report to the cloud.

The second API is, for example, an API for executing a process that enables a game operation on the rear seat of the vehicle by multimedia.

The third API is, for example, an API for executing a process of turning on the illuminations on the rear seat of the vehicle.

The use setting table TB1 indicates that there are three use setting items of the first API: “price range [yen/use]”, “range duration estimation time [minutes]”, and “time shift setting”.

The “price range [yen/use]” indicates the price range in which API is permitted to be used. The price range is expressed as a price when the API is used once.

The “range duration estimation time [minutes]” indicates the time during which the price set in the “price range [yen/use]” continues. That is, the use of API is permitted when the price set in the “price range [yen/use]” continues for the time set in the “range duration estimation time [minute]”.

The “time shift setting” is a setting for moving the timing of using the API when the use of the API is prohibited based on the setting contents of the “price range [yen/use]” and the setting contents of the “range duration estimation time [minute]”.

Then, in the use setting table TB1, the “price range [yen/use]” is set to “˜10” and the “range duration estimation time [minute]” is set to “15 minutes”. That is, when a state where the use price of the first API per one use is less than 10 yen continues for 15 minutes or more, the use of the first API is permitted.

Further, in the use setting table TB1, the setting content of the “time shift setting” can be set to any one of “any time”, “only when traveling”, and “only when parking”.

The use setting table TB2 indicates that there are three use setting items of the second API: “price range [yen/use]”, “range duration estimation time [minutes]”, and “time shift setting”. Then, in the use setting table TB2, the “price range [yen/use]” is set to “˜10” and the “range duration estimation time [minute]” is set to “15 minutes”. Further, in the use setting table TB2, the “time shift setting” is set to “OFF”. That is, when the use of the second API is prohibited, the timing of using the second API cannot be moved.

The use setting table TB3 indicates that three are three use setting items of the third API: “price range [yen/use]”, “range duration estimation time [minutes]”, “time shift setting”, and “option setting”.

The “option setting” is a setting for enabling the use of API when the use of API is prohibited based on the setting contents of “price range [yen/use]” and the setting contents of “range duration estimation time [minutes].

Then, in the use setting table TB3, the “price range [yen/use]” is set to “˜10”, the “range duration estimation time [minute]” is set to “15 minutes”, and the “time shift setting” is set to “OFF”.

Further, in the use setting table TB3, the “option setting” is set to “When there is level that is within available range with brightness level lowered, control amount is changed to corresponding level and control is executed” and “When there is no level that is within available range with brightness level lowered, it is not available”. That is, when the setting contents of the “price range [yen/use]” and the setting contents of the “range duration estimation time [minute]” can be satisfied by lowering the brightness level of the illumination in the rear seat of the vehicle, the use of the third API is permitted.

Next, a method for setting whether to permit the compulsory use of the service application by the user US will be described.

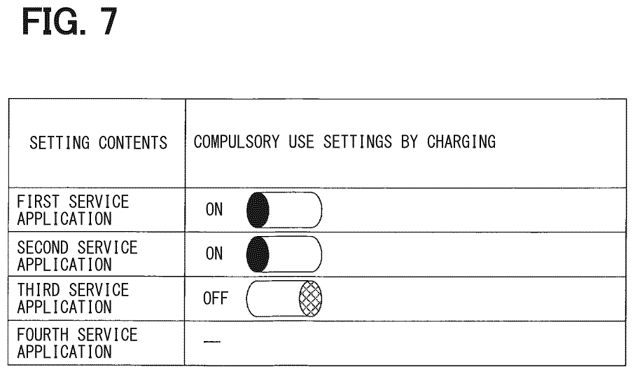

As shown in FIG. 7, settings for compulsory use by charging are performed for each of the multiple service applications. The compulsory use by charging means that even when the API use fee exceeds the setting content of the “price range [yen/use]”, the user is permitted to use the API by charging the user the API use fee for the excess amount.

For the first, second, and third service applications, either permission for compulsory use by charge or prohibition can be selected. The first and second service applications are set to permit compulsory use by charge, and the third service application is set to prohibit compulsory use by charge.

That is, the first and second service applications can use the API by charging the user US for amounts exceeding the setting content of the “price range [yen/use]”. The third service application cannot use the API when it exceeds the setting content of the “price range [yen/use]”.

For the fourth service application, it is not possible to set whether to permit the compulsory use by charge. This is because, for example, only resources borne by the user US, such as a decrease in the SOC of the battery, are listed as factors exceeding the setting content of the “price range [yen/use]” in the API used by the fourth service application. Therefore, the API use of the fourth service application is prohibited when it exceeds the setting content of “price range [yen/use]”.

As for the compulsory use permitted by charge from the user US, it is assumed that the API use fee will increase depending on the vehicle load. However, items for which the user US bears resources such as electricity bills, such as battery SOC decrease, are not subject to the compulsory use setting.

Examples of the factors causing the API fee to fluctuate due to the vehicle load include “the amount of calculation performed during API execution”, “the number of actuators to operate”, “the number of used sensors”, “the number of systems or ECUs to operate”, “the output power of the battery”, “the communication amount of the operation system API”, and the like.

The fee derived from the vehicle load is a burden amount corresponding to the amount paid by the user US for the vehicle resource in advance or after the fact.

For example, when the vehicle is a rental car, the user US does not pay the purchase fee of the vehicle itself (i.e., the user US does not purchase resources), so that the fee for charging the user based on the vehicle load is a payment burden with a relatively high percentage of the user burden.

On the other hand, when the vehicle is a private vehicle, it is necessary to take into account a vehicle purchase cost. That is, since the user US pays the purchase fee of the vehicle itself, the fee for charging the user based on the vehicle load is a payment burden with a relatively low percentage of the user burden. For example, a single CPU can be divided into an area where the user US bears the resource load and an area where the OEM bears the resource load. Fee (for example, fee incurred by temporarily ceding the data collection area used by the OEM) incurred by ceding only the vehicle load area borne by the OEM is targeted for user burden. The OEM is the vehicle manufacturer that produced the vehicle. The OEM is an abbreviation for original equipment manufacturer.

Next, a specific example in which the access control method determination unit 72 determines the access control method will be described.

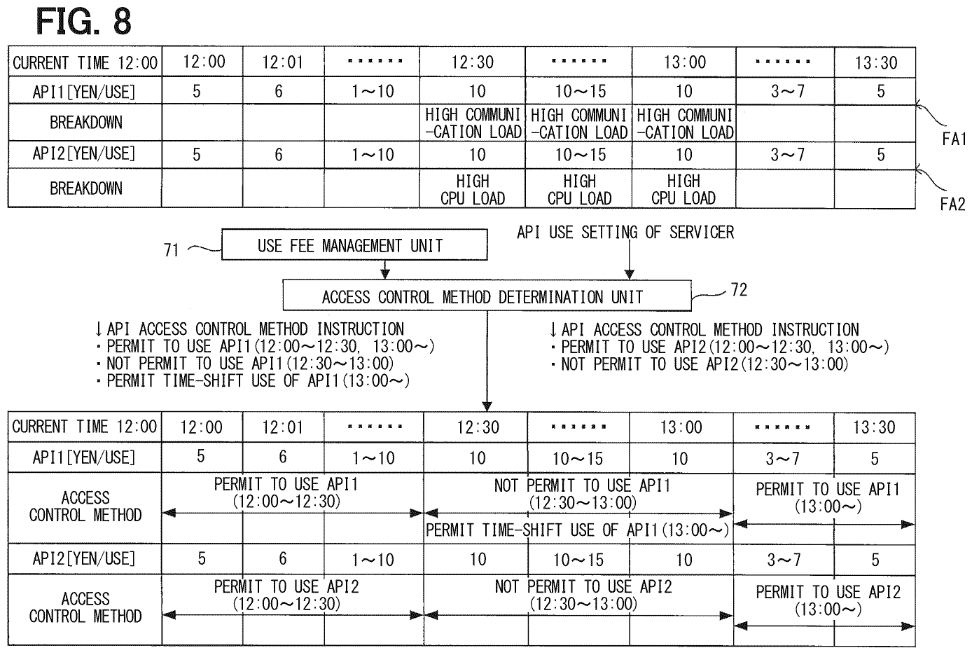

As shown in FIG. 8, the access control method determination unit 72 acquires the first API estimation amount information FA1 and the second API estimation amount information FA2 generated by the use fee management unit 71 from the use fee management unit 71.

The first API estimation amount information FA1 indicates the estimation amount of the first API use fee at each minute from 12:00 onward. The first API use fee is a fee per use of the first API.

The second API estimation amount information FA2 indicates the estimation amount of the second API use fee at each minute from 12:00 onward. The second API use fee is a fee per use of the second API.

In the first API estimation amount information FA1 and the second API estimation amount information FA2, the API use fee at the current time of 12:00 is 5 [yen/use]. The API use fee estimation amount at 12:01 is 6 [yen/use]. The API use fee estimation amount at 12:02 to 12:30 is 1 to 10 [yen/use]. The API use fee estimation amount at 12:30 is 10 [yen/use]. The API use fee estimation amount at 12:30 to 13:00 is 10 to 15 [yen/use]. The API use fee estimation amount at 13:00 is 10 [yen/use]. The API use fee estimation amount at 13:00 to 13:30 is 3 to 7 [yen/use]. The API use fee estimation amount at 13:30 is 5 [yen/use].

In the first API estimation amount information FA1, the API use fee estimation amount is equal to or more than 10 [yen/use] between 12:30 and 13:00 because the communication load increases. In the second API estimation amount information FA2, the API use fee estimation amount is equal to or more than 10 [yen/use] between 12:30 and 13:00 because the CPU load increases.

Therefore, the access control method determination unit 72 permits use of the first API from 12:00 to 12:30 and 13:00, prohibits the use from 12:30 to 13:00, and permits the use of the time shift from 13:00. Further, the access control method determination unit 72 permits the use of the second API from 12:00 to 12:30 and 13:00, and prohibits the use from 12:30 to 13:00.

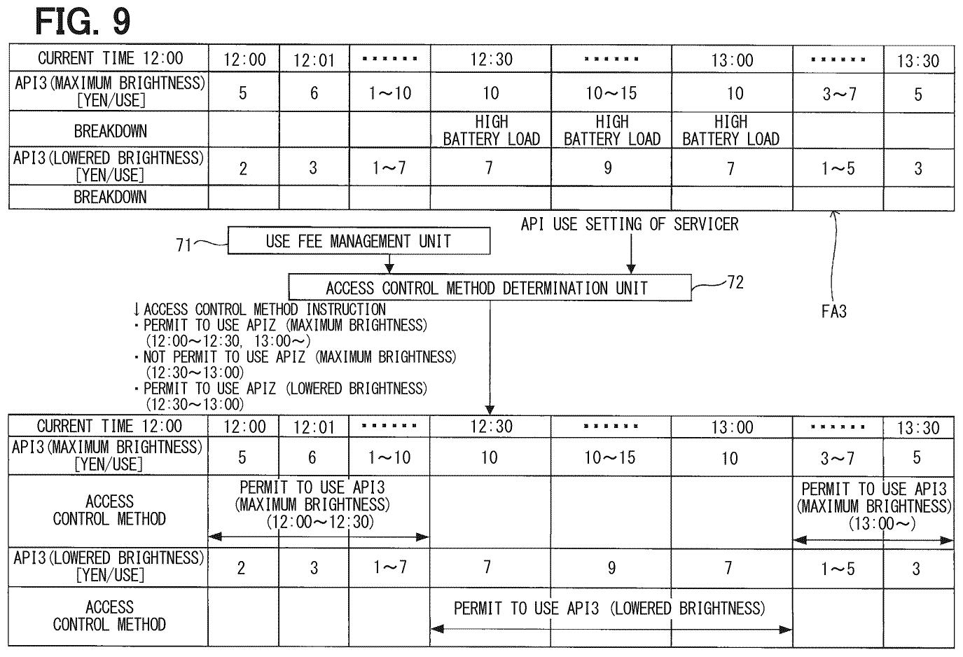

As shown in FIG. 9, the access control method determination unit 72 acquires the third API estimation amount information FA3 generated by the use fee management unit 71 from the use fee management unit 71.

The third API estimation amount information FA3 indicates the estimation amount of the third API use fee at each minute from 12:00 onward. The third API use fee is a fee per use of the third API.

The third API estimation amount information FA3 indicates the estimation amount of the third API use fee for both cases where the illumination is turned on with maximum brightness and cases where the illumination is turned on with lowered brightness.

When the illumination is turned on with maximum brightness, in the third API estimation amount information FA3, the API use fee at the current time of 12:00 is 5 [yen/use]. The API use fee estimation amount at 12:01 is 6 [yen/use]. The API use fee estimation amount at 12:02 to 12:30 is 1 to 10 [yen/use]. The API use fee estimation amount at 12:30 is 10 [yen/use]. The API use fee estimation amount at 12:30 to 13:00 is 10 to 15 [yen/use]. The API use fee estimation amount at 13:00 is 10 [yen/use]. The API use fee estimation amount at 13:00 to 13:30 is 3 to 7 [yen/use]. The API use fee estimation amount at 13:30 is 5 [yen/use]. In the third API estimation amount information FA3, the API use fee estimation amount is equal to or more than 10 [yen/use] between 12:30 and 13:00 because the battery load increases.

When the illumination is turned on with lowered brightness, in the third API estimation amount information FA3, the API use fee at the current time of 12:00 is 2 [yen/use]. The API use fee estimation amount at 12:01 is 3 [yen/use]. The API use fee estimation amount at 12:02 to 12:30 is 1 to 7 [yen/use]. The API use fee estimation amount at 12:30 is 7 [yen/use]. The API use fee estimation amount at 12:30 to 13:00 is 9 [yen/use]. The API use fee estimation amount at 13:00 is 7 [yen/use]. The API use fee estimation amount at 13:00 to 13:30 is 1 to 5 [yen/use]. The API use fee estimation amount at 13:30 is 3 [yen/use].

Therefore, the access control method determination unit 72 permits the use of the third API with the maximum brightness from 12:00 to 12:30 and 13:00, and prohibits the use with the maximum brightness from 12:30 to 13:00 and permits the use with the lowered brightness.

Next, specific examples of processes executed by the access permission determination unit 74 and the access control execution unit 75 will be described.

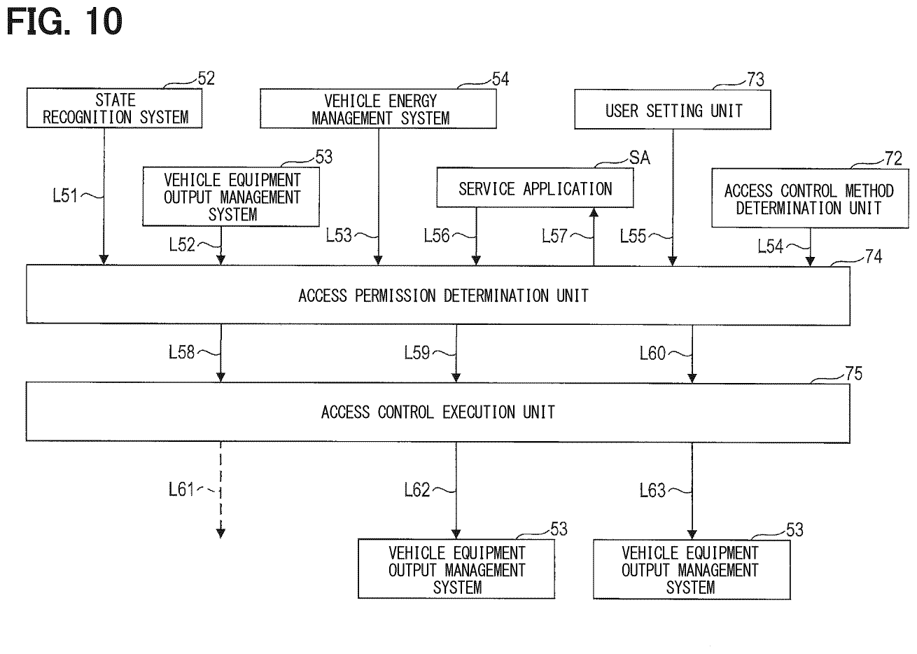

As shown in FIG. 10, the access permission determination unit 74 determines whether to permit the API according to the API access request based on future estimation availability information from the state recognition system 52, the vehicle equipment output management system 53, and the vehicle energy management system 54, access method control instructions from the access control method determination unit 72, and compulsory use permission from the user setting unit 73, and determines the access execution method described above.

Specifically, as indicated by an arrow L51, the state recognition system 52 notifies the access permission determination unit 74 of future estimation availability information indicating a future estimation of the available CPU usage, for example.

As indicated by an arrow L52, the vehicle equipment output management system 53 notifies the access permission determination unit 74 of future estimation availability information indicating a future estimation of the amount of available communication data, for example.

As indicated by an arrow L53, the vehicle energy management system 54 notifies the access permission determination unit 74 of, for example, future estimation availability information indicating a future estimation of the available battery usage.

As indicated by an arrow L54, the access control method determination unit 72 determines the access control method based on the API use conditions set by the servicer SV, and instructs the access permission determination unit 74 on the determined access control method.

As indicated by an arrow L55, the user setting unit 73 provides, to the access permission determination unit 74, instructions that indicate whether to permit the compulsory use and set by the user US.

As indicated by an arrow L56, the service application SA transmits the API access requests of the first API, the second API, and the third API to the access permission determination unit 74.

When receiving the API access request from the service application SA, the access permission determination unit 74 determines whether to permit the access in response to the access request based on the access control method for which instruction is provided from the access control method determination unit 72, the compulsory use permission for which instruction is provided from the user setting unit 73, and the future estimation availability information for which notification is provided from the state recognition system 52, the vehicle equipment output management system 53, and the vehicle energy management system 54, and generates the future estimation information regarding the access permission.

For example, the access permission determination unit 74 permits the use of the API when a state where the API use fee estimation amount does not exceed the setting content of the “price range [yen/use]” continues for more than the time set by the “range duration estimation time [minute]” and also the CPU usage amount generated by executing the API is within the available range.

For example, even when the API use fee estimation amount exceeds the setting content of the “price range [yen/use]”, the access permission determination unit 74 permits the use of the API as long as the compulsory use is permitted and also the CPU usage amount generated by executing the API is within the available range.

As indicated by an arrow L57, the access permission determination unit 74 notifies the service application SA of the access permission determination result in response to the received API access request and the future estimation information. The future estimation information includes, for example, information of “In X minutes, access control will disable API.”, information of “In Y minutes, the API will be available.”, information of “In Z minutes, vehicle load will be reduced and API charge will be reduced.”, and the like.

As indicated by an arrow L58, when the access permission determination unit 74 permits the use of the first API, it transmits an API access request of the first API and an API execution method instruction of the first API to the access control execution unit 75. The method of executing the first API is, for example, a method in which “the time is shifted at 13:00 to reserve the use of the API”.

As indicated by an arrow L59, when the access permission determination unit 74 permits the use of the second API, it transmits an API access request of the second API and an API execution method instruction of the second API to the access control execution unit 75. The second API execution method is, for example, a method in which “when the charge amount is equal to or greater than the upper limit amount, the user US charges for basic continuation”.

As indicated by an arrow L60, when the access permission determination unit 74 permits the use of the third API, it transmits an API access request from the third API and an API execution method instruction from the third API to the access control execution unit 75. The third API execution method is, for example, a method of “in principle, executing with maximum brightness, or executing with lowered brightness depending on the situation”.

As indicated by an arrow L61, the access control execution unit 75 transfers the API access request of the first API to the control system functional block group 35, for example, at 13:00. Thereby, for example, at the time of 13:00, a process of transmitting a driving operation report to the cloud is executed. A broken line in the arrow L61 indicates that the API access request is not transferred until 13:00.

The access control execution unit 75 transfers the API access request of the second API to the control system functional block group 35, as indicated by an arrow L62. Thereby, for example, the vehicle equipment output management system 53 executes a process that enables a game operation in the rear seat of the vehicle by multimedia.

As indicated by an arrow L63, the access control execution unit 75 transfers the API access request of the third API to the control system functional block group 35. Thereby, for example, the vehicle equipment output management system 53 executes a process of turning on the illumination at the rear seat of the vehicle with maximum brightness.

Next, specific examples of processes executed by the access control execution unit 75, the access log management unit 76, and the charge amount calculation unit 62 will be described.

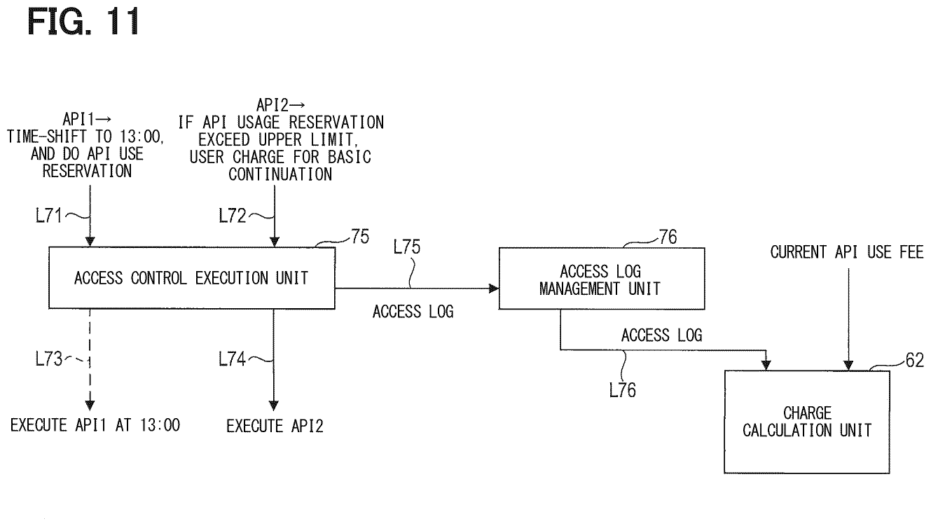

As shown in FIG. 11, the access control execution unit 75 acquires an API execution method instruction from the access permission determination unit 74 and transfers the API access request based on the API execution method instruction.

Specifically, as indicated by an arrow L71, the access control execution unit 75 acquires an API execution method instruction in which an execution method is set for the first API. The API execution method is a method of “shifting time at 13:00 to reserve the use of the API”.

As indicated by an arrow L72, the access control execution unit 75 acquires an API execution method instruction in which an execution method is set for the second API. The execution method is a method of “when the billing amount exceeds the upper limit, the user US will generally continue to bear the charges”.

As indicated by an arrow L73, the access control execution unit 75 transfers the API access request of the first API to the control system functional block group 35 at 13:00. A broken line in the arrow L73 indicates that the API access request of the first API is not transferred until 13:00.

As indicated by an arrow L74, the access control execution unit 75 transfers the API access request of the second API to the control system functional block group 35 immediately after acquiring the API access request of the second API.

As indicated by an arrow L75, the access control execution unit 75 generates an access log indicating the result of executing the process corresponding to the first and second APIs, and notifies the access log management unit 76 of the generated access log. When the second API is executed with the charge borne by the user US, the access control execution unit 75 adds information indicating this to the access log.

The access log management unit 76 transmits the access log acquired from the access control execution unit 75 to the charge amount calculation unit 62.

Based on the access log acquired from the access log management unit 76 and the current API use fee, the charge amount calculation unit 62 calculates the API use fee generated by the service application SA using the first and second APIs and the API use fee charged to the user US.

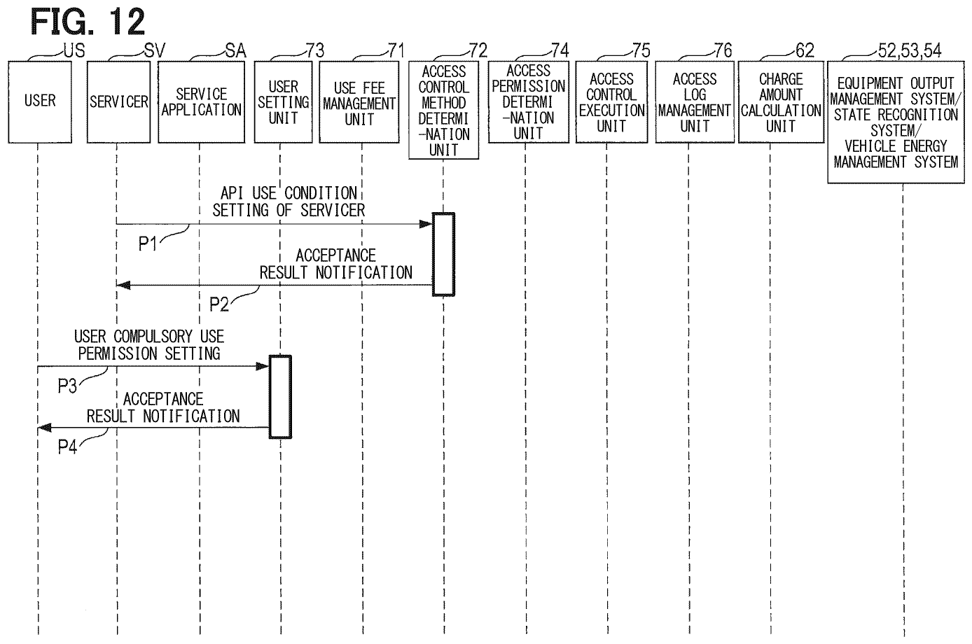

Next, as shown in FIG. 12, a procedure in which the servicer SV sets the API utilization conditions and a procedure in which the user US sets the API compulsory use permission will be described.

As shown in a process P1, the servicer SV accesses the application store 14 using the servicer terminal device 9, and sets the API use conditions. The application store 14 notifies the access control method determination unit 72 of the set API use conditions.

As shown in a process P2, upon acquiring the API use condition, the access control method determination unit 72 notifies the servicer terminal device 9 of an acceptance result indicating that the API use condition has been accepted via the application store 14.

As shown in a process P3, the user setting unit 73 sets whether to permit the compulsory use of API by the service application SA based on the input operation by the user US via the above-described input device mounted on the vehicle.

Then, as shown in the process P4, the user setting unit 73 notifies the user US of the acceptance result indicating that the set compulsory use has been accepted, for example, by displaying it on the display screen of the navigation device.

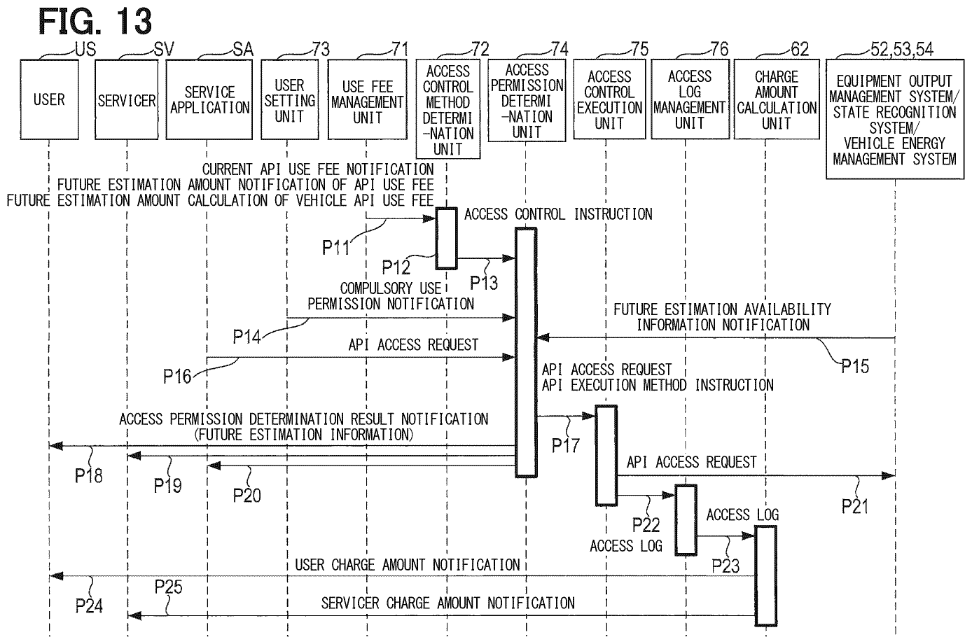

Next, as shown in FIG. 13, a procedure for determining the access permission will be described.

As indicated by a process P11, the use fee management unit 71 notifies the access control method determination unit 72 of the current API use fee calculated by the use fee management unit 71, and the future estimation amount of the API use fee, and the future estimation amount of the vehicle API use fee acquired from the application store 14.

As shown in a process P12, the access control method determination unit 72 determines the access control method based on the above information acquired from the use fee management unit 71 and the API use conditions acquired from the application store 14.

As shown in a process P13, the access control method determination unit 72 provides instructions of the determined access control method to the access permission determination unit 74.

As shown in a process P14, the user setting unit 73 provides instructions of whether the set compulsory use is permitted to the access permission determination unit 74.

Each of the state recognition system 52, the vehicle equipment output management system 53, and the vehicle energy management system 54 notifies the access permission determination unit 74 of the future estimation availability information as shown in a process P15.

As shown in a process P16, the service application SA transmits an API access request to the access permission determination unit 74.

The access permission determination unit 74 determines the access permission to the received API access request, and when permitting the use of the API, transmits the API access request and API execution method instruction to the access control execution unit 75, as shown in a process P17.

As shown in processes P18, P19, and P20, the access permission determination unit 74 notifies the user US, the servicer SV, and the service application SA of the access permission determination result and future estimation information for the API access request.

As shown in a process P21, the access control execution unit 75 transfers the API access request based on the API execution method instruction.

As indicated by a process P22, the access control execution unit 75 creates an access log indicating the API execution result according to the API access request, and notifies the access log management unit 76 of the generated access log.

As shown in a process P23, the access log management unit 76 transmits the access log acquired from the access control execution unit 75 to the charge amount calculation unit 62.

As shown in a process P24, the charge amount calculation unit 62 calculates the API use fee charged to the user US, and notifies the user US of the calculated charge amount.

As shown in a process P25, the charge amount calculation unit 62 calculates the API use fee generated by the service application SA using the API, and notifies the servicer SV of the calculated charge amount.

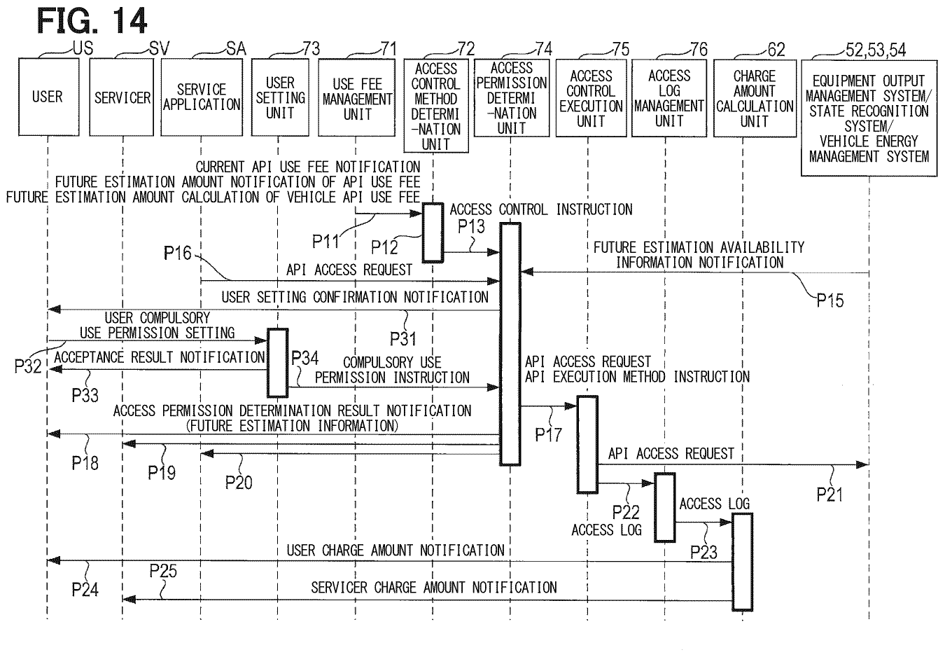

Next, as shown in FIG. 14, when the user US has not set the API compulsory permission, a procedure for causing the user US to set the API compulsory use permission will be described.

A sequence diagram of FIG. 14 differs from the sequence diagram of FIG. 13 in that processes P31 to P34 are executed instead of the process P14.

That is, when the service application SA transmits the API access request to the access permission determination unit 74 as shown in a process P16, the access permission determination unit 74 notifies the user US of the user setting confirmation as shown in a process P31. The user setting confirmation is displayed, for example, on the display screen of the navigation device.

As shown in a process P32, the user setting unit 73 sets whether to permit the compulsory use of API by the service application SA based on the input operation by the user US via the input device mounted on the vehicle.

Then, as shown in a process P33, the user setting unit 73 notifies the user US of the acceptance result indicating that the set compulsory use has been accepted, for example, by displaying it on the display screen of the navigation device.

Furthermore, as shown in a process P34, the user setting unit 73 provides instructions indicating whether the set compulsory use is possible to the access permission determination unit 74.

Next, the access permission determination unit 74 determines the access permission to the received API access request, and when the use of the API is permitted, instructs the access control execution unit 75 how to execute the API, as shown in a process P17.

The following process is the same as the sequence diagram of FIG. 13.

The ECU 4 configured in this manner is mounted on a vehicle and connected to multiple in-vehicle devices 5 to 7 by the vehicle interior communication network 8.

The ECU 4 includes an API gateway 40. The API gateway 40 implements cooperation between the service application SA configured to provide services to the vehicle and the control system functional block group 35 configured to execute a predetermined process in the vehicle.

The control system functional block group 35 includes the API group 37. The API group 37 converts the API access request expressed in the vehicle-independent format and transmitted from the service application SA into the vehicle-dependent format.

The API gateway 40 transfers the API access request transmitted from the service application SA to the control system functional block group 35.

The API gateway 40 includes an access control method determination unit 72 and an access permission determination unit 74.

The access control method determination unit 72 determines an access control method for controlling the transfer of the API access request to the control system functional block group 35 based on the current API use fee information, the API estimation amount information, and the API use conditions set for the servicer SV that provides services to the vehicle using the service application SA to use the API group 37.

Currently, the current API use fee information indicates the API use fee (hereinafter, referred to as current API use fee) generated by the service application SA using the API group 37 at the current time. The API estimation amount information indicates the estimation amount (hereinafter, future estimation amount) of API use fee that will occur due to the use of the API group 37 by the service application SA in the future.

The access permission determination unit 74 determines whether to permit the API access request based on the access control method determined by the access control method determination unit 72 and the request (that is, future estimation availability information) of the vehicle control system 2 including the multiple in-vehicle devices 5 to 7 and the ECU 4.

Such an ECU 4 can cause the service application SA to use the API group 37 when the current API use fee and the future estimation amount satisfy the API use conditions set by the servicer SV. Thereby, the ECU 4 can prevent the occurrence of a situation where the service application SA uses the API group 37 when the current API use fee and the future estimation amount are higher than the amount expected by the servicer SV. Therefore, the ECU 4 can reduce the fluctuation in charges generated by the servicer SV using the vehicle.

The API gateway 40 further includes a user setting unit 73. The user setting unit 73 sets whether to permit the compulsory use of the API group 37 by the service application SA by charging of the user US using the service application SA when the current API use fee and the future estimation amount are equal to or greater than a preset upper limit value (that is, the setting content of “price range [yen/use]”). The access permission determination unit 74 is further configured to determine whether to permit the API access request based on whether to permit the compulsory use. Thereby, the ECU 4 can cause the user US to use the service application SA without increasing the charges incurred by the servicer SV using the vehicle.

The API gateway 40 further includes the use fee management unit 71. The use fee management unit 71 acquires current vehicle information that is current information related to the vehicle and future vehicle information that is future information related to the vehicle based on information transmitted from the multiple in-vehicle devices 5 to 7, and calculates the estimation amount of the API use fee (hereinafter referred to as an individual vehicle future estimation amount) based on the current vehicle information and the future vehicle information. The current vehicle information is the current vehicle information described above, the current occupant information, the current peripheral information, the current equipment operation state information, and the current vehicle energy state information. The future vehicle information is the long-term plan of the vehicle operation, the vehicle CPU load profile, the vehicle equipment operation profile, and the energy long-term plan described above. The access permission determination unit 74 determines the access control method by using, as the above-described API estimation amount information, the individual vehicle future estimation amount information indicating the individual vehicle future estimation amount calculated by the use fee management unit 71.

Thereby, the ECU 4 can determine the access control method based on the information that can be acquired from the vehicle.

The API gateway 40 further includes an access log management unit 76. The access log management unit 76 creates an access log indicating the execution status of the API access request, and transmits the generated access log to the server 3 that is mounted outside the vehicle and includes the charge amount calculation unit 62 configured to calculate the charge amount based on the access log. Thereby, the ECU 4 can transmit the access log related to the API access request permitted by the access permission determination unit 74 to the server 3. Therefore, it is possible to reduce the fluctuation in charges caused by the servicer SV using the vehicle.

When determining to permit the API access request, the access permission determination unit 74 sets at least either a timing for executing a process according to the access request or a control amount of a control target to be controlled for executing a process according to the API access request. The timing setting in the present embodiment is the time shift setting described above. The control amount of the control target in the present embodiment is the brightness of the illumination.

The API use conditions described above include “price range [yen/use]” and “range continuation estimation time [minutes]”. Thereby, since the ECU 4 can prevent the service application SA from using the API group 37 during a time zone in which the API use fee fluctuates rapidly, it is possible to further reduce the fluctuation in the fee generated by the servicer SV using the vehicle.

The user setting unit 73 excludes service applications that use the API group 37 using only resources that the user US has already paid for, from the target of compulsory use permission. Thereby, the ECU4 can prevent a situation in which the user US is forced to bear additional charges due to the compulsory use, even though the user US is already paying for the service.

The access permission determination unit 74 notifies at least one of the service application SA, the servicer SV, or the user US using the service application SA of future estimation information indicating at least one of estimation of fluctuation in charge amount due to the API access request or estimation of use status of the API access request, based on the API estimation amount information and API use conditions. Thereby, the ECU 4 can encourage the service application SA, the servicer SV, and the user US to promote the use of the API group 37 or reduce the use of the API group 37.

When the API access request is executed by the compulsory use, the access log management unit 76 generates an access log with an addition indicating that the API access request has been executed by the compulsory use, and transmits the access log to the server 3. Thereby, the ECU 4 can cause the server 3 to appropriately calculate the charge amount generated for the user US due to the compulsory use.

The charge amount calculation unit 62 changes the charge amount depending on whether the vehicle is a rental car or a private vehicle. As a result, the application store 14 can appropriately charge user US according to the amount that user US pays for the vehicle resources either in advance or after use.

The access permission determination unit 74 notifies the user US of user setting confirmation to confirm the setting for the compulsory use when whether to permit the compulsory use is not set for the service application SA that has transmitted the API access request. Thereby, the ECU 4 can prevent the occurrence of a situation in which the compulsory use setting is not appropriately used because whether to permit the compulsory use is not set.

In the embodiment described above, the ECU 4 corresponds to an in-vehicle device, the ECU 5, the ECU 6, and the vehicle exterior communication device 7 correspond to multiple electronic control units, the vehicle interior communication network 8 corresponds to an in-vehicle network, the control system functional block group 35 corresponds to a functional block, the API gateway 40 corresponds to a cooperation controller, and the API group 37 corresponds to a functional interface.

Further, the current API use fee information corresponds to current interface use fee information, the API estimation amount information corresponds to future estimation amount information, and the API use condition corresponds to an interface use condition.

As described above, the embodiment of the present disclosure is described, but the present disclosure is not limited to the above embodiment, and can be implemented with various modifications.

### First Modification

In the above embodiment, the access control method determination unit 72 has shown a configuration of determining the access control method by using the individual vehicle unit future estimation amount information as the API estimation amount information. However, the server 3 capable of data communication with the vehicle control system 2 includes an API use fee calculation unit 61 configured to calculate a future estimation amount (hereinafter referred to as an external future estimation amount) of the future vehicle API use fee based on the individual vehicle future estimation amount information indicating the individual vehicle future estimation amount and future information related to the different system. The future information related to the different system corresponds to the future external system information. Therefore, the access control method determination unit 72 may determine the access control method by acquiring the external future estimation amount information indicating the external future estimation amount from the server 3 and using the acquired external future estimation amount information as the API estimation amount information described above. Thereby, since the ECU 4 can further determine the access control method based on future information regarding the different system, it is possible to further reduce the fluctuation in charges generated by the servicer SV using the vehicle.

### Second Modification

The above embodiment has shown a configuration in which the API use fee is generated when the service application SA transmits an API access request to the control system functional block group 35 via the API gateway 40. However, the service application SA may generate the API use fee by transmitting an API access request to the data system functional block group 36 via the API gateway 40. For example, the service application SA may transmit an API access request requesting data reading or the like to the data system functional block group 36.

The ECU 4 and the method thereof described in the present disclosure may be implemented by a dedicated computer provided by configuring a processor and a memory programmed to execute one or a plurality of functions embodied by a computer program. Alternatively, the ECU 4 and the method described in the present disclosure may be implemented by a dedicated computer provided by configuring a processor with one or more dedicated hardware logic circuits. Alternatively, the ECU 4 and the method thereof according to the present disclosure may be implemented using one or multiple dedicated computers constituted by a combination of the processor and the memory programmed to execute one or more functions and the processor with one or more hardware logic circuits. The computer program may be stored in a computer-readable non-transitional tangible storage medium as an instruction to be executed by the computer. The method for realizing the functions of the respective units included in the ECU 4 does not necessarily need to include software, and all of the functions may be implemented with the use of one or multiple hardware.

Multiple functions of one configuration element in the above-described embodiment may be implemented by multiple configuration elements, or one function of one configuration element may be implemented by multiple configuration elements. Multiple functions of multiple configuration elements may be implemented by one configuration element, or one function implemented by multiple configuration elements may be implemented by one configuration element. Further, a part of the configuration of the above embodiment may be omitted. At least a part of the configuration of the embodiment may be added to or replaced with another configuration of the embodiment.

The present disclosure may be implemented, in addition to the ECU 4 described above, various forms such as a system including the ECU 4 as a component, a program for causing a computer to function as the ECU 4, a non-transitory tangible storage medium including a semiconductor memory storing the program, a service providing method.

What is claimed is:

1. An in-vehicle device that is mounted on a vehicle and connected to a plurality of electronic control units by an in-vehicle network, the in-vehicle device comprising
at least one of (i) a circuit and (ii) a processor with a memory storing computer program code executable by the processor, the at least one of the circuit and the processor configured to cause the in-vehicle device to
implement cooperation between a service application configured to provide a service to the vehicle and a functional block configured to execute a process predetermined in the vehicle,
wherein
the functional block includes a functional interface configured to convert an access request that is expressed in a vehicle-independent format and transmitted from the service application into a vehicle-dependent format,
the at least one of the circuit and the processor is further configured to cause the in-vehicle device to:
transfer the access request transmitted from the service application to the functional block;
determine an access control method for controlling transfer of the access request to the functional block based on
current interface use fee information indicating a current interface use fee that is an interface use fee generated by the service application using the functional interface at a current time,
future estimation amount information indicating a future estimation amount that is an estimation amount of the interface use fee generated by the service application using the functional interface in future, and
an interface use condition set for using the functional interface by a servicer that provides the service to the vehicle by using the service application; and
determine whether to permit the access request based on the determined access control method and a request of a vehicle control system including the plurality of electronic control units and the in-vehicle device.

2. The in-vehicle device according to claim 1, wherein
the at least one of the circuit and the processor is further configured to cause the in-vehicle device to:
set whether to permit compulsory use of the functional interface by charging a user using the service application when the current interface use fee or the future estimation amount is equal to or higher than a preset upper limit value; and
determine whether to permit the access request based on whether to permit the compulsory use.

3. The in-vehicle device according to claim 1, wherein
the at least one of the circuit and the processor is further configured to cause the in-vehicle device to:
acquire current vehicle information that is current information related to the vehicle and future vehicle information that is future information related to the vehicle based on information transmitted from the plurality of electronic control units;
calculate an individual vehicle future estimation amount that is an estimation amount of the interface use fee based on the current vehicle information and the future vehicle information; and
determine the access control method by using, as the future estimation amount information, individual vehicle future estimation amount information indicating the calculated individual vehicle future estimation amount.

4. The in-vehicle device according to claim 1, wherein
the at least one of the circuit and the processor is further configured to cause the in-vehicle device to acquire external future estimation amount information that is an external future estimation amount from
a server that
calculates the external future estimation amount that is an estimation amount of the interface use fee in the future based on
individual vehicle future estimation amount information indicating an individual vehicle future estimation amount that
is an estimation amount of the interface use fee generated by the service application using, in the future, the functional interface and
is calculated based on current vehicle information that is current information related to the vehicle and future vehicle information that is future information related to the vehicle and
future external system information that is future information related to an external system existing in outside, and
communicates data with the vehicle control system, and
determines the access control method by using the acquired external future estimation amount information as the future estimation amount information.

5. The in-vehicle device according to claim 1, wherein
the at least one of the circuit and the processor is further configured to cause the in-vehicle device to:
generate an access log indicating an execution status of the access request; and
transmit the generated access log to a server that is placed outside the vehicle and calculates a charge amount based on the generated access log.

6. The in-vehicle device according to claim 1, wherein
when determining to permit the access request, the at least one of the circuit and the processor causes the in-vehicle device to set at least one of a timing for executing the process according to the access request or a control amount of a control target to be controlled for executing the process according to the access request.

7. The in-vehicle device according to claim 1, wherein
the interface use condition includes
a price range that is a range of the interface use fee for which use of the functional interface is permitted and
a range duration estimation time that is an estimation time for a state where the interface use fee continues to be within the price range.

8. The in-vehicle device according to claim 2, wherein
the at least one of the circuit and the processor is further configured to cause the in-vehicle device to exclude, from a target of whether to permit the compulsory use, the service application that uses the functional interface using only a resource for which the user has already paid a fee.

9. The in-vehicle device according to claim 1, wherein
the at least one of the circuit and the processor is further configured to cause the in-vehicle device to notify at least one of the service application, the servicer, or a user using the service application of future estimation information indicating at least one of an estimation of fluctuation in a charge amount due to the access request or an estimation of an use status of the access request based on the future estimation amount information and the interface use condition.

10. The in-vehicle device according to claim 2, wherein
the at least one of the circuit and the processor is further configured to cause the in-vehicle device to:
generate an access log indicating an execution status of the access request;
transmit the generated access log to a server that is placed outside the vehicle and calculates a charge amount based on the generated access log; and
when the process according to the access request is executed by the compulsory use, generate the access log with a notification indicating that the process has been executed, and transmit the generated access log to the server.

11. The in-vehicle device according to claim 5, wherein
the at least one of the circuit and the processor is further configured to cause the in-vehicle device to change the charge amount depending on whether the vehicle is a rental vehicle or a private vehicle.

12. The in-vehicle device according to claim 2, wherein
the at least one of the circuit and the processor is further configured to cause the in-vehicle device to notify the user of a user setting confirmation for confirming a compulsory use setting when whether to permit the compulsory use is not set for the service application that has transmitted the access request.

13. A service provision system comprising:
a vehicle control system that includes
a plurality of electronic control units mounted on a vehicle and connected to an in-vehicle network and
at least one of (i) a circuit and (ii) a processor with a memory storing computer program code executable by the processor, the at least one of the circuit and the processor configured to cause the vehicle control system to implement cooperation between a service application configured to provide a service to the vehicle and a functional block configured to execute a process predetermined in the vehicle; and
a server configured to communicate data with the vehicle control system,
wherein
the functional block includes a functional interface configured to convert an access request that is expressed in a vehicle-independent format and transmitted from the service application into a vehicle-dependent format,
the at least one of the circuit and the processor is further configured to:
transfer the access request transmitted from the service application to the functional block;
determine an access control method for controlling transfer of the access request to the functional block based on
current interface use fee information indicating a current interface use fee that is an interface use fee generated by the service application using the functional interface at a current time,
future estimation amount information indicating a future estimation amount that is an estimation amount of the interface use fee generated by the service application using the functional interface in future, and
an interface use condition set for using the functional interface by a servicer that provides the service to the vehicle by using the service application; and
determine whether to permit the access request based on the determined access control method and a request of the vehicle control system.

14. A service provision method executed by an in-vehicle device that is mounted on a vehicle and connected to a plurality of electronic control units by an in-vehicle network, the service provision method comprising causing the in-vehicle device includes: a functional interface configured to convert an access request that is expressed in a vehicle-independent format and transmitted from a service application configured to provide a service to the vehicle into a vehicle-dependent format; and at least one of (i) a circuit and (ii) a processor with a memory storing computer program code executable by the processor, the at least one of the circuit and the processor configured to cause the in-vehicle device to implement cooperation between the service application and a functional block configured to execute a process predetermined in the vehicle with the functional interface and transfer the access request transmitted from the service application to the functional block, to:
determine an access control method for controlling transfer of the access request to the functional block based on
current interface use fee information indicating a current interface use fee that is an interface use fee generated by the service application using the functional interface at a current time,
future estimation amount information indicating a future estimation amount that is an estimation amount of the interface use fee generated by the service application using the functional interface in future, and
an interface use condition set for using the functional interface by a servicer that provides the service to the vehicle by using the service application; and
determine whether to permit the access request based on the determined access control method and a request of a vehicle control system including the plurality of electronic control units and the in-vehicle device.

15. A non-transitory computer-readable storage medium storing a service provision program causing a computer of an in-vehicle device that is mounted on a vehicle and connected to a plurality of electronic control units by an in-vehicle network to function as:
a functional interface configured to convert an access request that is expressed in a vehicle-independent format and transmitted from a service application configured to provide a service to the vehicle into a vehicle-dependent format;
a cooperation controller configured to implement cooperation between the service application and a functional block configured to control the vehicle with the functional interface and transfer the access request transmitted from the service application to the functional block;
an access control method determination unit configured to determine an access control method for controlling transfer of the access request to the functional block based on
current interface use fee information indicating a current interface use fee that is an interface use fee generated by the service application using the functional interface at a current time,
future estimation amount information indicating a future estimation amount that is an estimation amount of the interface use fee generated by the service application using the functional interface in future, and
an interface use condition set for using the functional interface by a servicer that provides the service to the vehicle by using the service application; and
an access permission determination unit configured to determine whether to permit the access request based on the access control method determined by the access control method determination unit and a request of a vehicle control system including the plurality of electronic control units and the in-vehicle device.
